(19) United States
(12) Patent Application Publication
(10) Pub. No.: US 2026/0245336 A1
(43) Pub. Date: Aug. 20, 2026

(54) TRAINING DATA DETERMINATION METHOD, TARGET DETECTION METHOD, DEVICE, AND MEDIUM

(71) Applicant: Beijing Zitiao Network Technology Co., Ltd., Beijing (CN)

(72) Inventors: Manlin ZHANG, Beijing (CN); Jie WU, Beijing (CN); Yuxi REN, Beijing (CN); Ming LI, Beijing (CN); Xuefeng XIAO, Beijing (CN)

(21) Appl. No.: 19/162,031

(22) PCT Filed: Mar. 22, 2024
(86) PCT No.: PCT/CN2024/083193

§ 371 Date: Sep. 3, 2025

(30) Foreign Application Priority Data
Mar. 22, 2023 (CN) 202310288309.4

(51) Int. Cl. G06V 10/44; G06T 5/70; G06V 10/764

(52) U.S. Cl. CPC G06V 10/454; G06T 5/70; G06V 10/764

(57) ABSTRACT

A training data determination method, a target detection method, a device, and a medium are provided. The method includes: obtaining a first image; performing an image generation process on the first image, to obtain at least one feature map and a second image, in which the second image is determined based on the at least one feature map, and the at least one feature map is determined based on the first image; determining, based on the at least one feature map, a target detection box corresponding to the second image; and determining training data based on the second image and the target detection box corresponding to the second image.

The present application claims priority to Chinese Patent Application No. 202310288309.4, filed on Mar. 22, 2023, which is incorporated herein by reference in its entirety as a part of the present application.

### TECHNICAL FIELD

The present disclosure relates to a training data determination method and apparatus, a target detection method and apparatus, a device, and a medium.

### BACKGROUND

With the development of image processing technologies, target detection models have been more and more widely used in the vision field. For example, the target detection models can be used in vision fields such as scene recognition, scene understanding, and the like.

In fact, to ensure detection performance of a target detection model, it is necessary to train the target detection model in advance using high-quality image training data carrying detection box annotations, so that a trained target detection model has a good detection performance.

However, detection boxes carried in the foregoing training data are usually obtained through manual annotation. This requires high resource costs (for example, labor costs and time costs), making it difficult to obtain training data.

### SUMMARY

The present disclosure provides a training data determination method and apparatus, a target detection method and apparatus, a device, and a medium, so as to effectively reduce the difficulty in obtaining training data.

To achieve the foregoing objective, the present disclosure provides the following technical solutions.

The present disclosure provides a training data determination method. The method includes:
obtaining a first image;
performing an image generation process on the first image, to obtain at least one feature map and a second image, in which the second image is determined based on the at least one feature map, and the at least one feature map is determined based on the first image;
determining, based on the at least one feature map, a target detection box corresponding to the second image; and
determining training data based on the second image and the target detection box corresponding to the second image.

In a possible implementation, the method further includes:
obtaining image generation constraint information corresponding to the first image; and
the performing an image generation process on the first image, to obtain at least one feature map and a second image includes:
performing the image generation process on the first image based on the image generation constraint information, to obtain the at least one feature map and the second image, in which the at least one feature map is determined based on the first image and the image generation constraint information.

In a possible implementation, the performing the image generation process on the first image based on the image generation constraint information, to obtain the at least one feature map and the second image includes:
determining the at least one feature map and the second image by using a first diffusion model that is pre-constructed, the image generation constraint information, and the first image.

In a possible implementation, the image generation constraint information includes a condition prompt text; and
a process of determining the at least one feature map and the second image includes:
performing feature extraction on the condition prompt text, to obtain a condition prompt feature; and
inputting the condition prompt feature and the first image into the first diffusion model, to obtain the at least one feature map and the second image.

In a possible implementation, the first diffusion model includes a denoising module and a decoding module, the denoising module is used to perform a plurality of noise reduction processes on input data of the denoising module, and input data of the decoding module includes a processing result of the last noise reduction process;
the at least one feature map is determined based on an intermediate feature generated during the last noise reduction process; and
the second image is determined based on output data of the decoding module.

In a possible implementation, the image generation constraint information includes at least one of a group consisting of a random seed, an encoding rate, a guidance scale, and a condition prompt text.

In a possible implementation, after the determining training data based on the second image and the target detection box corresponding to the second image, the method further includes:
adjusting part or all of constraint items in the image generation constraint information, and continuing to perform the step of performing the image generation process on the first image based on the image generation constraint information, to obtain the at least one feature map and the second image, until a first end condition is satisfied.

In a possible implementation, the obtaining a first image includes:
determining the first image from a training dataset;
the determining training data based on the second image and the target detection box corresponding to the second image includes:
updating the training dataset by using the second image and the target detection box corresponding to the second image; and
the method further includes:
when the first end condition is satisfied, continuing to perform the step of determining the first image from a training dataset, until a second end condition is satisfied.

In a possible implementation, the determining, based on the at least one feature map, a target detection box corresponding to the second image includes:
processing the at least one feature map by using a first detection network that is pre-constructed, to obtain the target detection box corresponding to the second image.

In a possible implementation, a construction process of the first detection network includes:
training a first data processing model by using a plurality of third images and a detection box label corresponding to each third image, in which the first data processing model includes a second diffusion model and a second detection network, and a parameter in the second diffusion model is not updated during a training process of the first data processing model; and
determining the first detection network based on a second detection network in a trained first data processing model.

In a possible implementation, the second image is generated by using a first diffusion model that is pre-constructed; and
the second diffusion model is determined based on the first diffusion model.

In a possible implementation, the second image is generated by using a pre-constructed first diffusion model; the first diffusion model is used to perform a first number of noise reduction processes; and
the second diffusion model is used to perform a second number of noise reduction processes, in which the second number is less than the first number.

In a possible implementation, the training process of the first data processing model includes:
determining an image to be used from the plurality of third images;
inputting the image to be used into the first data processing model, to obtain a detection box prediction result corresponding to the image to be used and output by the first data processing model; and
updating the second detection network in the first data processing model based on the detection box prediction result and the detection box label, and continuing to perform the step of determining an image to be used from the plurality of third images, until a preset stop condition is satisfied.

In a possible implementation, the detection box prediction result is determined by the second detection network through processing at least one feature map corresponding to the image to be used, and
the at least one feature map corresponding to the image to be used is determined by the second diffusion model through processing the image to be used.

In a possible implementation, the at least one feature map includes a plurality of feature maps, sizes of different feature maps are different; and
the processing the at least one feature map by using a first detection network pre-that is constructed, to obtain the target detection box corresponding to the second image includes:
constructing a pyramid feature by using the plurality of feature maps; and
inputting the pyramid feature into the first detection network, to obtain the target detection box corresponding to the second image.

In a possible implementation, a process of determining the second image and the target detection box corresponding to the second image includes:
determining, by using a second data processing model that is pre-constructed and the first image, the second image and the target detection box corresponding to the second image, in which the second data processing model includes a first diffusion model and a first detection network; the first diffusion model is used to perform the image generation process on the first image, to obtain the at least one feature map and the second image; and the first detection network is used to determine, based on the at least one feature map, the target detection box corresponding to the second image.

The present disclosure provides a target detection method. The method includes:
obtaining an image to be detected; and
inputting the image to be detected into a target detection model that is pre-constructed, to obtain a target detection result output by the target detection model, in which the target detection model is constructed based on training data; and the training data is determined by using the training data determination method according to the present disclosure.

The present disclosure provides a training data determining apparatus. The apparatus includes:
a first obtaining unit, configured to obtain a first image;
an image generation unit, configured to perform an image generation process on the first image, to obtain at least one feature map and a second image, in which the second image is determined based on the at least one feature map, and the at least one feature map is determined based on the first image;
a detection box determining unit, configured to determine, based on the at least one feature map, a target detection box corresponding to the second image; and
a data determining unit, configured to determine training data based on the second image and the target detection box corresponding to the second image.

The present disclosure provides a target detection apparatus. The apparatus includes:
a second obtaining unit, configured to obtain an image to be detected; and
a target detection unit, configured to input the image to be detected into a target detection model that is pre-constructed, to obtain a target detection result output by the target detection model, in which the target detection model is constructed based on training data; and the training data is determined by using the training data determination method according to the present disclosure.

The present disclosure provides an electronic device. The device includes a processor and a memory,
the memory is configured to store instructions or a computer program; and
the processor is configured to execute the instructions or the computer program in the memory, to cause the electronic device to perform the training data determination method or the target detection method according to the present disclosure.

The present disclosure provides a computer-readable medium having instructions or a computer program stored therein, the instructions or the computer program, when run on a device, causes the device to perform the training data determination method or the target detection method according to the present disclosure.

The present disclosure provides a computer program product, which includes a computer program carried on a non-transitory computer-readable medium, the computer program includes program codes for performing the training data determination method or the target detection method according to the present disclosure.

### BRIEF DESCRIPTION OF DRAWINGS

To describe the technical solutions in the embodiments of the present disclosure more clearly, the accompanying drawings for describing the embodiments are briefly described below. Apparently, the accompanying drawings in the following description are merely some embodiments recited in the present disclosure, and persons of ordinary skill in the art may still derive other accompanying drawings from these accompanying drawings without creative efforts.

FIG. 1 is a flowchart of a training data determination method according to embodiments of the present disclosure;

FIG. 2 is a schematic diagram of a training data augmentation process according to embodiments of the present disclosure;

FIG. 3 is a flowchart of a target detection method according to embodiments of the present disclosure;

FIG. 4 is a schematic diagram of a structure of a training data determination apparatus according to embodiments of the present disclosure;

FIG. 5 is a schematic diagram of a structure of a target detection apparatus according to embodiments of the present disclosure; and

FIG. 6 is a schematic diagram of a structure of an electronic device according to embodiments of the present disclosure.

### DETAILED DESCRIPTION

In order for persons skilled in the art to better understand the solutions of the present disclosure, the technical solutions in the embodiments of the present disclosure are described below clearly and completely with reference to the accompanying drawings in the embodiments of the present disclosure. Apparently, the embodiments described are merely some rather than all of the embodiments of the present disclosure. All other embodiments obtained by persons of ordinary skill in the art based on the embodiments of the present disclosure without any creative efforts shall fall within the scope of protection of the present disclosure.

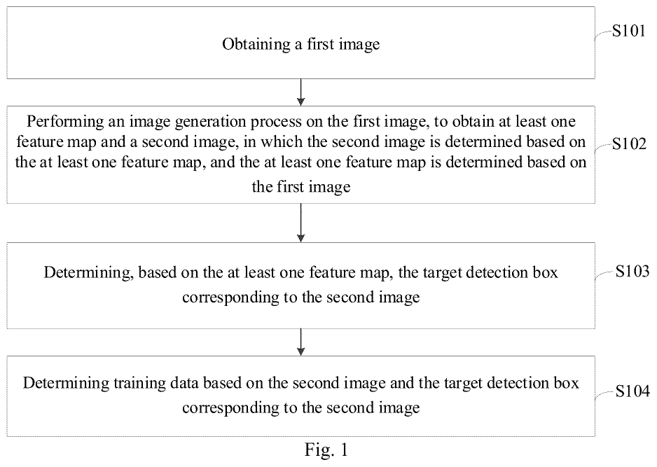

For a better understanding of the technical solution according to the present disclosure, a training data determination method according to the present disclosure is described below with reference to some accompanying drawings. As shown in FIG. 1, the training data determination method according to the embodiments of the present disclosure includes the following S101 to S104. FIG. 1 is a flowchart of a training data determination method according to the embodiments of the present disclosure.

S101: obtaining a first image.

The first image is image data that needs to be referenced during generation of a new image. In addition, the present disclosure does not limit the first image. For example, the first image may be any piece of image data.

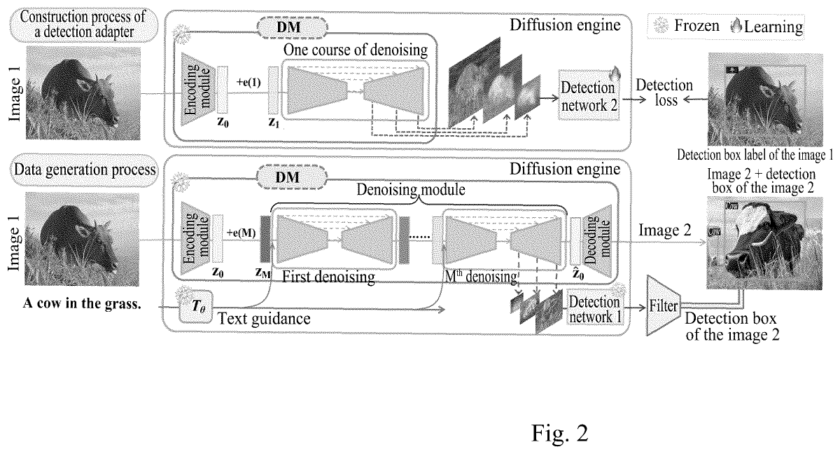

For another example, in some application scenarios (for example, augmenting a piece of training data), the first image may be image data (for example, an image 1 in FIG. 2) that exists in an existing training dataset in a certain application field (for example, the target detection field). The training dataset may include at least one piece of image data and label information of the image data (for example, a detection box label and/or a class label). The detection box label is used to indicate a position, in the image data, of one or more targets (for example, a physical object or an animal) in the image data. The class label is used to represent a class to which the one or more targets in the image data belong (for example, a class label “cow” shown in FIG. 2).

In addition, the present disclosure does not limit a process of obtaining the first image. For example, the first image may be obtained by using any existing or future image data obtaining method (for example, a method of acquiring by using an image acquisition device or a method of searching from a network). For another example, when the training data determination method according to the present disclosure is used for augmenting a training dataset in a certain application field (for example, the target detection field), the process of obtaining the first image may be specifically: randomly selecting a piece of image data from an existing training dataset in the field, and determining the image data as the first image.

Based on the related content of the foregoing S101, it can be learned that in some application scenarios, when the training data determination method according to the present disclosure is used for augmenting a training dataset in a certain application field (for example, the target detection field), a piece of image data (for example, the image 1 shown in FIG. 2) may be first randomly extracted from the training dataset as the first image, so that anew image (for example, an image 2 shown in FIG. 2) can be automatically generated subsequently based on the first image. In this way, the new image has a reasonable layout (for example, similar to a layout of the first image), which helps improve image quality of the new image, thereby improving data quality of training data determined based on the new image.

S102: performing an image generation process on the first image, to obtain at least one feature map and a second image, in which the second image is determined based on the at least one feature map, and the at least one feature map is determined based on the first image.

The second image is a new image generated based on the first image. For example, when the first image is the image 1 shown in FIG. 2, the second image may be the image 2 shown in FIG. 2.

The foregoing “at least one feature map” is an intermediate feature generated during the generation process of the foregoing second image, and the “at least one feature map” can represent image information carried by the second image. For example, the “at least one feature map” may include all feature maps generated during an M^{th} denoising process shown in FIG. 2.

In addition, the present disclosure does not limit an implementation of the “at least one feature map”. For example, the “at least one feature map” may include a plurality of feature maps of different sizes (for example, a feature map with a resolution of 8×8, a feature map with a resolution of 16×16, and a feature map with a resolution of 32×32, which are generated at up-sampling steps of 8, 16, and 32 respectively during a continuous up-sampling process involved in a denoising module in a diffusion model), so that a pyramid feature can be subsequently constructed based on the feature maps, so that the pyramid feature can better represent the image information carried by the second image.

In addition, the present disclosure does not limit an implementation of the foregoing S102. For example, S102 may be implemented by using any existing or future method that can be used to perform an image generation process based on an image.

In fact, to better improve the image generation effect, the present disclosure further provides a possible implementation of the foregoing S102, which may be specifically: performing the image generation process on the first image based on image generation constraint information corresponding to the first image, to obtain the at least one feature map and the second image, in which the second image is determined based on the at least one feature map, and the at least one feature map is determined based on the first image and the image generation constraint information.

The image generation constraint information corresponding to the first image is constraint information (or guidance information) that needs to be referenced during the generation of the new image based on the first image. For example, when the first image is the image 1 shown in FIG. 2, the image generation constraint information may include at least an image description text “A cow in the grass” shown in FIG. 2.

In addition, the present disclosure does not limit the image generation constraint information. For example, in the present disclosure, when the image generation process is implemented by using a diffusion model (DM), the image generation constraint information may include at least one of a group consisting of a random seed, an encoding rate, a guidance scale, and a condition prompt text. The random seed is used to assist in generation of random numbers in an image generation process of the DM. The encoding rate is used to control an intensity of noise added by the DM to an original image. The stronger the noise, the greater the difference between a denoised image and the original image. The guidance scale is used to adjust a degree of control of the condition prompt text over a generation result. The higher the guidance scale, the stronger the semantic consistency between a generated image and the condition prompt text. The lower the guidance scale, the more diverse the generated image, that is, the larger the room left for the DM to play freely. The condition prompt text is used to indicate semantic information carried by the generated image.

It should be noted that the diffusion model may usually include two phases: forward diffusion and reverse diffusion. In the forward diffusion phase, the image data is polluted by gradually introduced noise until the image becomes completely random noise. In the reverse diffusion phase, data is recovered from Gaussian noise through gradual noise reduction at each time step by using a series of Markov chains. In addition, when the diffusion model is applied to the field of image generation, the diffusion model has the ability to preserve a semantic structure of data, so that the diffusion model can generate diverse images, without being subjected to impact of mode collapse.

It should be further noted that for the random seed, the random seed is used to generate a random number by using a random number as an object and with a true random number (seed) as an initial condition. In addition, a random number of a computer is usually a pseudo-random number generated through continuous iteration based on a certain algorithm, with a true random number (seed) as an initial condition. In addition, because some image generation processes (for example, an image generation process that is implemented based on the diffusion model) are essentially random processes, different image data may be generated by configuring different random seeds, to improve image data diversity.

It should be further noted that the present disclosure does not limit an implementation of the foregoing condition prompt text. For example, for the first image, if there is an image description text corresponding to the first image (for example, the image description text “A cow in the grass” shown in FIG. 2), the image description text may be determined as the condition prompt text; or if there is no image description text corresponding to the first image, the condition prompt text may be implemented by using a preset generic prompt text “A [Domain], with [CLASS-1], [CLASS-2], . . . in the [Domain].”, [Domain] indicates a filed to which the image data belongs, and [CLASS-i] indicates a name (or a class) of a target appearing in the image data. For another example, in some application scenarios, the condition prompt text may be implemented by using text data input by a user.

In addition, the present disclosure does not limit a process of obtaining the foregoing image generation constraint information. For example, the image generation constraint information may be manually input by the user, or may be generated automatically according to a preset rule. The present disclosure is not specifically limited in this aspect.

Based on the foregoing content, it can be learned that in a possible implementation, the first image (for example, the image 1 shown in FIG. 2) and the image generation constraint information corresponding to the first image (for example, the image description text “A cow in the grass” shown in FIG. 2) may be first obtained. Then, the image generation process is performed on the first image under the guidance of the image generation constraint information, to obtain the at least one feature map (for example, three feature maps generated during the M^{th} denoising process shown in FIG. 2) and the second image (for example, the image 2 shown in FIG. 2), so that the at least one feature map is determined based on the first image and the image generation constraint information, and the second image is determined based on the at least one feature map. In this way, the second image not only has a reasonable layout (for example, similar to the layout of the first image), but also has a certain difference from the first image, which helps improve the diversity of the image data.

In fact, to better improve the image generation effect, the foregoing S102 may be implemented by using a first diffusion model. Based on this, the present disclosure provides a possible implementation of the foregoing S102, which may be specifically: determining the at least one feature map and the second image by using the pre-constructed first diffusion model, the first image, and the image generation constraint information corresponding to the first image.

The first diffusion model is used to perform the image generation process on input data of the first diffusion model. In addition, the embodiments of the present disclosure do not limit an implementation of the first diffusion model. For example, the first diffusion model may be implemented by using any existing or future diffusion model, for example, a latent diffusion model (LDM).

In addition, the present disclosure does not limit a construction process of the foregoing first diffusion model. For example, the construction process may be implemented by using any existing or future method that can be used to construct a diffusion model with an image generation function.

In addition, the present disclosure does not limit a model structure of the foregoing first diffusion model. For example, the first diffusion model may include an encoding module, a noise addition module, a denoising module, and a decoding module. In addition, input data of the noise addition module includes output data of the encoding module; input data of the denoising module includes output data of the noise addition module; and input data of the decoding module includes output data of the denoising module (for example, when the denoising module is used to perform a plurality of noise reduction processes on the input data of the denoising module, the input data of the decoding module includes a processing result of the last noise reduction process).

The encoding module is used to encode (for example, encode as shown in the following formula (1)) the input data of the encoding module (for example, the image 1 shown in FIG. 2), to obtain an encoded feature (for example, z₀ shown in FIG. 2).

$${z}_{0} = ℰ ( x ) \qquad ( 1 )$$

In the formula, z₀ represents an encoded feature obtained by encoding image data x; x represents a piece of image data (for example, the first image); and ε(x) represents encoding the image data x.

In addition, the present disclosure does not limit an implementation of the encoding module. For example, the encoding module may be implemented by using a module with an encoding function (for example, the encoding module shown in FIG. 2) in any existing or future diffusion model.

The noise addition module is used to perform at least one noise addition process (for example, a plurality of noise addition processes, or one noise addition process in which noise of a magnitude corresponding to the number of time steps for sampling is added at one time) on the input data of the noise addition module, so that the noise addition module is used to implement a forward diffusion phase in the foregoing first diffusion model.

In addition, the present disclosure does not limit an operating principle of the noise addition module. For example, the noise addition module may implement forward diffusion by performing the plurality of noise addition processes. For another example, the noise addition module may implement forward diffusion by performing the one noise addition process in which the noise of the magnitude corresponding to the number of time steps for sampling is added at one time. For ease of understanding, the following provides descriptions with reference to examples.

Example 1: When the noise addition module may implement forward diffusion by performing the plurality of noise addition processes, the noise addition module may include a plurality of noise addition sub-modules. One noise addition sub-module is used to perform one noise addition process (for example, a noise addition process shown in the following formula (2)) on input data of the noise addition sub-module. It should be noted that one noise addition process may also be referred to as a noise addition process for one time step. It should be further noted that the present disclosure does not limit a manner of connecting the “plurality of noise addition sub-modules”. For example, the “plurality of noise addition sub-modules” may be connected in any existing or future manner of connecting a plurality of noise addition sub-modules (for example, a cascading manner). It should be further noted that the present disclosure does not limit the number of the “plurality of noise addition sub-modules” either. For example, the number may be M shown in FIG. 2, where M is a positive integer. For another example, the number of the “plurality of noise addition sub-modules”=k×50, where k may be obtained through random sampling from an interval [0.3, 1.0].

$${z}_{t} = {α}_{t} {z}_{t - 1} + {σ}_{t} ϵ , ϵ ∼ 𝒩 ( ϵ \vert 0 , I ) \qquad ( 2 )$$

In the formula, zₜ represents output data of a t^{th} noise addition sub-module. zₜ₋₁ represents input data of the t^{th} noise addition sub-module. If t=1, z₀ represents the output data of the foregoing encoding module; or if t≥2, zₜ₋₁ represents output data of a (t−1)^{th} noise addition sub-module. ϵ represents Gaussian noise, belonging to a standard Gaussian distribution. αₜ and σₜ are determined by the noise addition module.

Example 2: When the noise addition module may implement forward diffusion by performing the one noise addition process in which the noise of the magnitude corresponding to the number of time steps for sampling is added at one time, the operating principle of the noise addition module is specifically: after the number of time steps (for example, M shown in FIG. 2) is obtained, first sampling the noise of the magnitude corresponding to the number of time steps from a pre-constructed mapping relationship, so that the noise can indicate a magnitude of noise that needs to be added when noise addition processes for this number of time steps are completed at one time; and performing one noise addition process (for example, a noise addition process shown in the following formula (3)) on the input data of the noise addition module (for example, a piece of image data) by using the noise again, to obtain a noise addition result (for example, z_{M} shown in FIG. 2). The mapping relationship is used to record noise of a magnitude corresponding to each candidate number of time steps, so that the noise corresponding to the candidate number of time steps can indicate the magnitude of noise that needs to be added during forward diffusion with the candidate number of time steps.

$${z}_{M} = {z}_{0} + e ( M ) = {α}_{M} {z}_{0} + {σ}_{M} ϵ , ϵ ∼ 𝒩 ( ϵ \vert 0 , I ) \qquad ( 3 )$$

In the formula, z_{M} represents the output data of the noise addition module. M represents the number of time steps. E represents Gaussian noise, belong to a standard Gaussian distribution. α_{M} and σ_{M} are determined by the noise addition module. z₀ represents the output data of the foregoing encoding module. e(M) represents noise that needs to be added when noise addition processes for M steps are completed at one time. It should be noted that the present disclosure does not limit a manner of obtaining M. For example, M=k×50, where k may be obtained through random sampling from an interval [0.3, 1.0].

In addition, the present disclosure does not limit an implementation of the noise addition module. For example, the noise addition module may be implemented by using a module with a noise addition function in any existing or future diffusion model.

The denoising module is used to perform at least one noise reduction process (for example, a plurality of noise reduction processes, or a noise reduction process shown in the following formula (4) and formula (5)) on the input data of the denoising module, so that the denoising module is used to implement a reverse diffusion phase in the foregoing first diffusion model.

$${\hat{z}}_{0} = {ϵ}_{θ} ( {z}_{M} , M , {c}_{p} ) \qquad ( 4 )$$

$${c}_{p} = {T}_{θ} ( P ) \qquad ( 5 )$$

In the formula, \hat{z}₀ represents an output result of the denoising module. z_{M} represents the input data of the denoising module, that is, the output data of the foregoing noise addition module, that is, data obtained by performing noise addition processes for M time steps. M represents the number of time steps, that is, the number of noise reduction times. P represents the foregoing condition prompt text. T_{θ}(P) represents performing feature extraction on P. The present disclosure does not limit an implementation of the feature extraction. For example, the feature extraction may be implemented by using a contrastive language-image pre-training (CLIP) model. cₚ represents an embedding feature of P (for example, a text embedding feature obtained based on the CLIP model). ϵ_{θ}(z_{M}, M, cₚ) represents performing M noise reduction processes on the input data z_{M} of the denoising module by using cₚ as guidance information. It should be noted that the present disclosure does not limit a manner of obtaining M involved in the denoising module. For example, M may be obtained by outputting, by the foregoing noise addition module, an embedding feature of M to the denoising module. For another example, M may alternatively be obtained in other ways. This is not specifically limited in the present disclosure.

In addition, the present disclosure does not limit the denoising module. For example, the denoising module may be implemented by using any existing or future network structure that can implement a plurality of noise reduction processes (for example, U-Net). For another example, in some application scenarios, the denoising module may include a plurality of denoising sub-modules. One denoising sub-module is used to perform one noise reduction process on input data of the denoising sub-module. It should be noted that the present disclosure does not limit a manner of connecting the “plurality of denoising sub-modules”. For example, the “plurality of denoising sub-modules” may be connected in any existing or future manner of connecting a plurality of denoising sub-modules (for example, a cascading manner). It should be further noted that the present disclosure does not limit the number of the “plurality of denoising sub-modules”. For example, the number of the “plurality of denoising sub-modules” is equal to the “number of time steps”.

In addition, the present disclosure does not limit an implementation of the denoising module. For example, the denoising module may be implemented by using a module with a denoising function (for example, a U-Net based denoising module) in any existing or future diffusion model.

Based on the related content of the foregoing first diffusion model, it can be learned that in some application scenarios, the first diffusion model may implement the image generation process through forward diffusion+reverse diffusion (for example, through a plurality of noise addition processes+a plurality of noise reduction processes). Based on this, the present disclosure further provides an implementation of the foregoing S102. When the “image generation constraint information corresponding to the first image” includes at least the condition prompt text (for example, the image description text “A cow in the grass” shown in FIG. 2), S102 may specifically include the following step 11 and step 12.

Step 11: performing feature extraction on the condition prompt text, to obtain a condition prompt feature.

The condition prompt feature is used to represent semantic information carried by the foregoing condition prompt text. In addition, the present disclosure does not limit a process of obtaining the condition prompt feature. For example, the process may be implemented by using the foregoing formula (5).

Step 12: inputting the condition prompt feature and the first image into the first diffusion model, to obtain the at least one feature map and the second image.

In the present disclosure, after the first image and the condition prompt feature corresponding to the first image are obtained, the two pieces of data may be input into the pre-constructed first diffusion model, so that the first diffusion model can process the first image by using the condition prompt feature as guidance information, to obtain the at least one feature map and the second image. For ease of understanding, the following provides descriptions with reference to examples.

In an example, when the foregoing first diffusion model includes the encoding module, the noise addition module, the denoising module, and the decoding module, the foregoing step 12 may specifically include the following step 121 to step 124.

Step 121: encoding the first image by using the encoding module, to obtain an encoded feature of the first image.

The encoded feature of the first image is used to represent image information carried by the first image.

Based on the related content of the foregoing step 121, it can be learned that for the foregoing first diffusion model, after the first image (for example, the image 1 shown in FIG. 2) is input into the first diffusion model, the encoding module (for example, the encoding module shown in FIG. 2) in the first diffusion model may encode (for example, encode as shown in the foregoing formula (1)) the first image, to obtain the encoded feature of the first image (for example, z₀ shown in FIG. 2), so that the encoded feature can represent the image information carried by the first image.

Step 122: performing a noise addition process on the encoded feature of the foregoing first image by using the noise addition module, to obtain a noise addition result.

The noise addition result is data obtained by the foregoing first diffusion model through performing forward diffusion on the first image.

In addition, the present disclosure does not limit an implementation of step 122. For example, when the foregoing noise addition module implements forward diffusion by performing the one noise addition process in which the noise of the magnitude corresponding to the number of time steps for sampling is added at one time, step 122 may be specifically: after the encoded feature z₀ of the first image and the number M of time steps for sampling are obtained, first determining the noise of the magnitude corresponding to M; and performing one noise addition process (for example, the noise addition process shown in the foregoing formula (3)) on the encoded feature z₀ according to the noise, to obtain the foregoing noise addition result z_{M}. This can effectively improve noise addition efficiency, helping improve data generation efficiency.

Based on the related content of the foregoing step 122, for the foregoing first diffusion model, after the encoding module in the first diffusion model outputs the encoded feature of the first image (for example, z₀ shown in FIG. 2), the noise addition module in the first diffusion model performs the noise addition process on the encoded feature for a plurality of time steps, to obtain the noise addition result (for example, z_{M} shown in FIG. 2), so that the noise addition result can represent the data obtained by the first diffusion model through performing forward diffusion on the first image.

Step 123: performing a noise reduction process on the foregoing noise addition result by using the denoising module, to obtain a denoising result and the at least one feature map.

The denoising result is data obtained by the foregoing first diffusion model through performing forward diffusion and reverse diffusion on the first image.

In addition, the present disclosure does not limit an implementation of step 123. For example, as shown in FIG. 2, when the foregoing denoising module includes M denoising sub-modules, step 123 may be specifically: after the foregoing denoising result z_{M} is obtained, the first denoising sub-module performing a noise reduction process for the first time on the denoising result z_{M} with reference to the foregoing condition prompt feature, to obtain denoised data \hat{z}_{M-1} output by the first denoising sub-module; then the second denoising sub-module performing, with reference to the condition prompt feature, a noise reduction process for the second time on the “denoised data \hat{z}_{M-1} output by the first denoising sub-module”, to obtain denoised data \hat{z}_{M-2} output by the second denoising sub-module; then the third denoising sub-module performing, with reference to the condition prompt feature, a noise reduction process for the third time on the “denoised data \hat{z}_{M-2} output by the second denoising sub-module”, to obtain denoised data \hat{z}_{M-3} output by the third denoising sub-module; . . . (and so on). Then, an M^{th} denoising sub-module performing, with reference to the condition prompt feature, a noise reduction process for the M^{th} time on the “denoised data \hat{z}₁ output by an (M−1)^{th} denoising sub-module”, to obtain denoised data \hat{z}₀ output by the M^{th} denoising sub-module, which is used as the foregoing denoising result. In addition, the feature maps generated during the M^{th} noise reduction process performed by the M^{th} denoising sub-module may be obtained (for example, when the M^{th} denoising sub-module is implemented by using the U-net, the feature map with the resolution of 8×8, the feature map with the resolution of 16×16, and the feature map with the resolution of 32×32 may be extracted from three phases of a decoder of the U-Net), where M is a positive integer. It can be learned that in a possible implementation, the “at least one feature map” may be determined based on an intermediate feature generated during the last noise reduction process (for example, the M^{th} noise reduction process shown in FIG. 2).

It should be noted that the first time involved in the present disclosure may also be referred to as the first time step; the second time may also be referred to as the second time step; . . . (and so on).

Based on the related content of the foregoing step 123, it can be learned that for the foregoing first diffusion model, after the noise addition module in the first diffusion model outputs the foregoing noise addition result (for example, z_{M} shown in FIG. 2), the denoising module in the first diffusion model performs the plurality of noise reduction processes (for example, the M noise reduction processes shown in FIG. 2) on the noise addition result, to obtain the denoising result (for example, \hat{z}₀ shown in FIG. 2) and the at least one feature map (for example, the three feature maps extracted during the M^{th} noise reduction process shown in FIG. 2), so that the second image and a target detection box corresponding to the second image can be subsequently determined based on the two pieces of data. See below for the related content of the target detection box.

Step 124: decoding the foregoing denoising result by using the decoding module, to obtain the foregoing second image.

In the present disclosure, for the foregoing first diffusion model, after the denoising module in the first diffusion model outputs the foregoing denoising result (for example, \hat{z}₀ shown in FIG. 2), the decoding module in the first diffusion model (for example, the decoding module shown in FIG. 2) may decode the denoising result to obtain and output the foregoing second image (for example, the image 2 shown in FIG. 2). It can be learned that in a possible implementation, the second image may be determined based on the output data of the decoding module (for example, the image 2 shown in FIG. 2).

Based on the related content of the foregoing step 121 to step 124, it can be learned that after the first image and the image generation constraint information corresponding to the first image are obtained, the foregoing first diffusion model may perform the image generation process (for example, the image generation process shown in FIG. 2) on the first image under the guidance of the image generation constraint information, and the first diffusion model outputs the second image and the at least one feature map corresponding to the second image.

Based on the related content of the foregoing step 11 and step 12, it can be learned that in some application scenarios, after the first image (for example, the image 1 shown in FIG. 2) and the image generation constraint information corresponding to the first image are obtained, if the image generation constraint information includes at least the condition prompt text (for example, the image description text “A cow in the grass” shown in FIG. 2), the first image and the condition prompt feature extracted from the condition prompt text may be input into the pre-constructed first diffusion model, so that the first diffusion model can perform the image generation process (for example, the image generation shown in FIG. 2) on the first image under the guidance of the condition prompt feature, to obtain and output the at least one feature map (for example, the three feature maps extracted during the M^{th} denoising process shown in FIG. 2) and the second image (for example, the image 2 shown in FIG. 2). In this way, the at least one feature map can represent the image information carried by the second image (for example, information such as implicit semantics and position knowledge used by the first diffusion model to generate the second image), and the second image can have a certain difference from the first image while having a reasonable layout. The feature maps have different sizes, so that the feature maps can represent the structure of the second image in a variety of resolutions, and the feature maps can better represent the information carried by the second image. Therefore, the detection box determined subsequently based on the feature maps can more accurately represent a position of a physical object in the second image.

Based on the related content of the foregoing S102, it can be learned that in a possible implementation, after the first image and the image generation constraint information corresponding to the first image are obtained, some processing (for example, encoding process, noise addition process, and noise reduction process) may be performed on the first image based on the image generation constraint information, to obtain the at least one feature map, so that the feature maps can represent image information of a new image to be generated. Then, some processing is performed on the feature maps to obtain the new image as the second image. In this way, the second image not only has a reasonable layout (for example, similar to the layout of the first image), but also has a certain difference from the first image, which helps improve diversity of the image data.

S103: determining, based on the at least one feature map, the target detection box corresponding to the second image.

The target detection box corresponding to the second image is used to indicate a position of at least one target (for example, a cow) in the second image. For example, when the second image is the image 2 shown in FIG. 2, the target detection box corresponding to the second image may include a detection box of the image 2 shown in FIG. 2.

In addition, the present disclosure does not limit an implementation of the foregoing S103. For example, S103 may be implemented by using any existing or future method that can be used to perform detection (for example, detection box detection, or detection box detection+class detection) based on a plurality of feature maps.

In fact, to better improve the detection effect of the detection box, the present disclosure further provides a possible implementation of the foregoing S103, which may be specifically: processing the foregoing at least one feature map by using a pre-constructed first detection network, to obtain the target detection box corresponding to the second image.

The first detection network is used to perform detection (for example, detection box detection, or detection box detection+class detection) on input data of the first detection network. In addition, the present disclosure does not limit an implementation of the first detection network. For example, the first detection network may be implemented by using any existing or future network structure with a detection function (for example, a detection box detection function, or a detection box detection function+a class determination function). It can be learned that in a possible implementation, the first detection network may be used only to perform detection for a detection box on the input data of the first detection network. In another possible implementation, the first detection network may be used to perform detection for a detection box and perform class detection on the input data of the first detection network, so that a detection result determined by the first detection network for the input data may include the target detection box and a target class. The target class is used to describe a class to which the at least one target appearing in the input data belongs (for example, a class “cow” shown in FIG. 2).

In addition, the present disclosure does not limit an operating principle of the foregoing first detection network. For example, the operating principle may be specifically: directly inputting the foregoing at least one feature map into the first detection network, to obtain the target detection box (or the target detection box and the target class) that corresponds to the second image and that is output by the first detection network.

In fact, to better improve the detection effect of the detection box, the present disclosure further provides another possible implementation of the operating principle of the foregoing first detection network. In this implementation, when the foregoing at least one feature map includes a plurality of feature maps, and any two of the plurality of feature maps have different sizes, the operating principle of the first detection network may include the following step 21 and step 22.

Step 21: constructing a pyramid feature by using the foregoing plurality of feature maps.

The pyramid feature is a result obtained by arranging the foregoing plurality feature maps in a descending order of size (or in an ascending order of size), so that the pyramid feature includes a plurality of feature maps arranged in the form of a pyramid.

Step 22: inputting the foregoing pyramid feature into the first detection network, to obtain the target detection box (or the target detection box and the target class) corresponding to the second image.

In the present disclosure, after the foregoing pyramid feature is obtained, the pyramid feature is input into the pre-constructed first detection network, so that network layers corresponding to different sizes in the first detection network can be used to perform corresponding processing on feature maps of the corresponding sizes, and then the first detection network can perform detection on the pyramid feature, and obtain and output the target detection box (or the target detection box and the target class) corresponding to the foregoing second image. In this way, the detection box can represent the position, in the second image, of the at least one target in the second image (and the target class can indicate the class to which the at least one target in the second image belongs). Feature maps of different sizes can represent information of different scales of the second image, so that the pyramid feature determined based on the feature maps can represent information of different scales of the second image, which helps improve target detection performance (for example, detection accuracy) for the second image.

Based on the related content of the foregoing step 21 and step 22, it can be learned that in a possible implementation, after the plurality of feature maps corresponding to the foregoing second image are obtained, the feature maps are first arranged based on the sizes of the feature maps, to obtain the pyramid feature. The pyramid feature is then input into the first detection network, so that the first detection network performs detection on the pyramid feature, and obtains and outputs the target detection box corresponding to the foregoing second image. In this way, the detection box can indicate the position, in the second image, of the at least one target in the second image.

In addition, the present disclosure does not limit the implementation of the foregoing first detection network. For example, the first detection network may be implemented by using any existing or future network structure (for example, a detection head) that has at least a detection function for the detection box.

Based on the related content of the foregoing first detection network, it can be learned that for the first detection network according to the present disclosure, the first detection network (for example, a detection head) is used to directly perform detection on the feature maps, rather than directly perform detection on the image data, so that the first detection network does not need to perform feature extraction on the image data, which helps improve detection efficiency of the first detection network. Because the foregoing feature maps carry implicit semantics and position information related to a piece of image data, the first detection network can perform detection based on the implicit semantics and the position information, which helps improve detection accuracy of the first detection network.

In addition, the present disclosure does not limit a construction process of the foregoing first detection network. For example, the process may be implemented by using any existing or future method that can be used to construct the first detection network.

In fact, to better improve the detection performance of the foregoing first detection network, the present disclosure further provides a possible implementation of the construction process of the foregoing first detection network, which may specifically include the following step 31 and step 32.

Step 31: training a first data processing model by using a plurality of third images and a detection box label corresponding to each third image, in which the first data processing model includes a second diffusion model and a second detection network, and a parameter in the second diffusion model is not updated during a training process of the first data processing model.

The third image is image data required for constructing the first detection network. For example, the third image may be the image 1 shown in FIG. 2.

In addition, the present disclosure does not limit an implementation of the “plurality of third images”. For example, the “plurality of third images” may be implemented by using image data in any existing or future training dataset including the image data and a detection box label corresponding to an image two-tuple.

In addition, the present disclosure does not limit an association relationship between the “plurality of third images” and the foregoing first image either. For example, the “plurality of third images” may include the first image, or may not include the first image. It can be learned that when the first image is from a training dataset that needs to be augmented, an image dataset for constructing the first detection network may be from the training dataset that needs to be augmented or from other places. This is not specifically limited in the present disclosure.

The detection box label corresponding to the third image is used to describe an actual position of a target (for example, a physical object or an animal) in the third image. For example, when the third image is the image 1 shown in FIG. 2, the detection box label corresponding to the third image may be a detection box label of the image 1 shown in FIG. 2.

In addition, the present disclosure does not limit a manner of obtaining the “detection box label corresponding to the third image”. For example, the manner may be implemented through manual annotation.

The first data processing model is used to perform detection (for example, detection for a detection box, or detection for a detection box+class detection) on input data of the first data processing model. For example, the first data processing model may implement the detection purpose through one noise addition process and one noise reduction process. It can be learned that in a possible implementation, the first data processing model may be a diffusion engine including one denoising sub-module shown in FIG. 2.

In fact, for the first data processing model, the first data processing model may include the second diffusion model and the second detection network, and input data of the second detection network includes an intermediate feature (for example, all feature maps generated when the noise reduction process is performed) generated when the second diffusion model performs the image generation process. For ease of understanding, the related content of the second diffusion model and the second detection network is described below.

The second diffusion model is used to perform the image generation process on input data of the second diffusion model. In addition, the present disclosure does not limit an implementation of the second diffusion model. For example, the second diffusion model may be implemented by using any existing or future diffusion model (for example, an LDM).

Further, the present disclosure does not limit an association relationship between the foregoing second diffusion model and the foregoing first diffusion model. For example, there is no association relationship between the second diffusion model and the first diffusion model.

For another example, the number of noise reduction times in the foregoing second diffusion model is less than the number of noise reduction times in the first diffusion model. It can be learned that in a possible implementation, when the first diffusion model is used to perform noise addition processes for a first number of time steps (for example, M shown in FIG. 2) and perform a first number (that is, the first number of time steps) of noise reduction processes, the second diffusion model is used to perform noise addition processes for a second number of time steps (for example, 1 shown in FIG. 2) and perform a second number (that is, the second number of time steps) of noise reduction processes, in which the second number is less than the first number.

In fact, to better improve the detection effect of the foregoing first detection network on the feature maps generated by the foregoing first diffusion model, the present disclosure further provides a possible implementation of the foregoing second diffusion model. The second diffusion model may be determined based on the first diffusion model, so that the second diffusion model is partially or completely the same as the first diffusion model.

In addition, the present disclosure does not limit a process of determining the second diffusion model shown in the above paragraph. For example, the process may be specifically as follows. When the first diffusion model includes a plurality of denoising sub-modules, the second diffusion model may include a preset number of denoising sub-modules, in which the preset number is less than the number of sub-modules in the plurality of denoising sub-modules. That is, the number of denoising sub-modules in the second diffusion model is less than the number of denoising sub-modules in the first diffusion model, so that an intermediate feature generated when the second diffusion model performs the image generation process (that is, a feature map generated by the last denoising sub-module) can still accurately describe image information carried by the foregoing third image. In this way, impact caused by excessive noise addition can be significantly avoided, helping improve the construction effect of the following first detection network.

The preset number may be set in advance, and the preset number is equal to the foregoing second number. For example, when input data of the foregoing second detection network includes the feature map generated when the foregoing second diffusion model performs the last noise reduction process, the preset number may be 1, so that the input data of the foregoing second detection network (for example, a plurality of feature maps) can still accurately describe the image information carried by the foregoing third image. That is, in a possible implementation, the foregoing second diffusion model may include at least one denoising sub-module.

Based on the content of the foregoing two paragraphs, it can be learned that in a possible implementation, when the pre-constructed first diffusion model includes the plurality of denoising sub-modules, the foregoing second diffusion model may include at least one denoising sub-module, so that the second diffusion model can implement the image generation process by performing one reverse diffusion process. The second diffusion model performs noise addition on a third image for only one time step, so that output data of a noise addition module in the second diffusion model can still accurately represent the image information carried by the third image. In this way, the feature map generated when the denoising sub-module in the second diffusion model performs the noise reduction process on the output data for one time step can still accurately represent the image information carried by the third image, so that the detection box subsequently determined by the foregoing second detection network for the feature map can indicate predicted positions of some targets in the third image.

The second detection network is used to perform a prediction process (for example, detection for a detection box, or detection for a detection box+class detection) on the input data (for example, the three feature maps shown in FIG. 2) of the second detection network. In addition, the present disclosure does not limit the second detection network. For example, the second detection network may be implemented by using any existing or future network structure with a detection function (for example, a detection function for a detection box, or a detection function for a detection box+a class detection function).

In addition, the present disclosure does not limit the input data of the foregoing second detection network. For example, when the foregoing second diffusion model includes one denoising sub-module, the input data of the second detection network may include a feature map generated when the denoising sub-module performs the noise reduction process. For another example, when the foregoing second diffusion model includes the preset number of denoising sub-modules, the input data of the second detection network may include the feature map generated when the last denoising sub-module performs the noise reduction process (that is, a feature map generated during the noise reduction process at the last time step). For another example, when the foregoing second diffusion model includes a plurality of denoising sub-modules, the input data of the second detection network may include a feature map generated when a Q^{th} denoising sub-module performs the noise reduction process (that is, a feature map generated during the noise reduction process at a Q^{th} time step), where Q is a positive integer; and Q is less than the number of denoising sub-modules in the “plurality of denoising sub-modules”, for example, Q=1.

Based on the content of the above paragraph, it can be learned that in some application scenarios, when the foregoing second detection network may be used to perform a small number of noise reduction processes (that is, the number of time steps is small), an intermediate feature generated during the last noise reduction process in the second detection network may be directly used as the input data of the foregoing second detection network. For another example, when the foregoing second detection network may be used to perform a large number of noise reduction processes (that is, the number of time steps is large), an intermediate feature generated during a certain noise reduction process in the second detection network may be used as the input data of the foregoing second detection network. It can be learned that in a possible implementation, the input data of the second detection network may include the intermediate feature generated during a Q^{th} noise reduction process in the second detection network, where Q is less than or equal to an actual number of noise reduction processes performed in the second detection network (for example, the total number of denoising sub-modules in the second detection network).

In fact, in some application scenarios, to better improve detection performance, the foregoing first data processing model may include a second diffusion model in a frozen state and a second detection network requiring learning training, so that the first data processing model is trained mainly for the following purpose. The second detection network learns to align implicit semantics and position knowledge in the second diffusion model with a detection perception signal, to predict a detection box (or a target class).

Based on the content of the above paragraph, it can be learned that in a possible implementation, the training process of the foregoing first data processing model (that is, an implementation of the foregoing step 31) may specifically include the following step 311 to step 314.

Step 311: determining an image to be used from the plurality of third images.

The image to be used is image data that needs to be used during a current training process for the foregoing first data processing model. For example, the image to be used may be the image 1 shown in FIG. 2.

In addition, the present disclosure does not limit an implementation of the foregoing step 311. For example, step 311 may be specifically: randomly selecting one or more images from all images in the plurality of third images that have not been traversed, and determining the selected image(s) as the image to be used, so that the image to be used can be used for model training in the current training process.

Step 312: inputting the image to be used into the first data processing model, to obtain a detection box prediction result corresponding to the image to be used and output by the first data processing model.

The detection box prediction result corresponding to the image to be used is used to describe a predicted position of a target in the image to be used. In addition, the present disclosure does not limit a process of determining the “detection box prediction result corresponding to the image to be used”. For example, when the foregoing first data processing model includes the second diffusion model and the second detection network, and the second diffusion model includes at least an encoding module, a noise addition module, and a denoising module, the process of determining the “detection box prediction result corresponding to the image to be used” may specifically include the following step 3121 to step 3124.

Step 3121: encoding the image to be used (for example, the image 1 shown in FIG. 2) by using the encoding module in the foregoing second diffusion model, to obtain an encoded feature of the image to be used (for example, z₀ shown in FIG. 2), so that the encoded feature can represent image information carried by the image to be used.

It should be noted that the related content of step 3121 is similar to the related content of the foregoing step 121. For brevity, details are not described herein again.

Step 3122: performing a noise addition process on the encoded feature of the foregoing image to be used by using the foregoing noise addition module in the second diffusion model, to obtain a one-time noise addition result (for example, z₁ shown in FIG. 2), so that the one-time noise addition result can still represent the image information carried by the image to be used.

It should be noted that the related content of step 3122 is similar to the related content of the noise addition module involved in the foregoing step 122. For brevity, details are not described herein again.

It should also be noted that the foregoing one-time noise addition result is data obtained by performing the noise addition process on the encoded feature of the foregoing image to be used for one time step.

Step 3123: performing a noise reduction process on the foregoing one-time noise addition result by using the denoising module in the foregoing second diffusion model, and determining, from an intermediate feature generated by the denoising module, at least one feature map corresponding to the foregoing image to be used, so that the feature map can represent the image information carried by the image to be used.

It should be noted that the related content of step 3123 is similar to the related content of the feature map involved in the foregoing step 123. For brevity, details are not described herein again.

It should also be noted that, to ensure that the at least one feature map corresponding to the foregoing image to be used better represents the image information carried by the image to be used, the denoising module in the foregoing second diffusion model performs the noise reduction process without reference to any guidance information (for example, the foregoing condition prompt text). Based on this, it can be learned that in a possible implementation, the denoising module in the second diffusion model may perform the noise reduction process without a condition signal (for example, as shown in the following formula (6)).

$${\hat{z}}_{0} = {ϵ}_{θ} ( {z}_{1} , 1 , {c}_{∅} ) \qquad ( 6 )$$

In the formula, \hat{z}₀ represents an output result of the denoising module in the foregoing second diffusion model. z₁ represents an output result of the noise addition module in the foregoing second diffusion model. c_{ø} represents that there is no condition signal (that is, no guidance information is referenced).

Step 3124: detecting the at least one feature map corresponding to the foregoing image to be used by using the foregoing second detection network, to obtain the detection box prediction result corresponding to the image to be used.

It should be noted that the related content of step 3124 is similar to the related content of the detection performed by using the first detection network in the foregoing S103. For brevity, details are not described herein again.

Based on the related content of the foregoing step 3121 to step 3124, it can be learned that for the first data processing model including the second diffusion model and the second detection network, after the image to be used is input into the first data processing model, the second diffusion model in the first data processing model first performs processing (for example, encoding, one noise addition process, and one noise reduction process) on the image to be used, to obtain the at least one feature map corresponding to the image to be used, so that the feature map can represent the image information carried by the image to be used. Then, the second detection network in the first data processing model performs processing (for example, detection for a detection box) on the at least one feature map corresponding to the image to be used, to obtain the detection box prediction result corresponding to the image to be used, so that the detection box prediction result can represent a predicted position of a physical object in the image to be used. In this way, the detection performance for a detection box of the second detection network can be measured subsequently based on the detection box prediction result.

Based on the related content of the foregoing step 312, it can be learned that for the current training process, after the image to be used is obtained, processing (for example, encoding, one noise addition process, one noise reduction process, and detection for a detection box) may be performed on the image to be used by using the first data processing model, to obtain a detection box prediction result corresponding to the image to be used, so that the detection performance for a detection box of the second detection network can be measured subsequently based on the detection box prediction result.

Step 313: determining whether a preset stop condition is satisfied. When the preset stop condition is satisfied, the training process of the first data processing model ends; or when the preset stop condition is not satisfied, the following step 314 is performed.

The preset stop condition is a condition that needs to be satisfied for ending the training process of the first data processing model. In addition, the present disclosure does not limit the preset stop condition. For example, the preset stop condition may be specifically: a detection loss of the first data processing model being lower than a preset first threshold. For another example, the preset stop condition may alternatively be: a rate of change of a detection loss of the first data processing model being lower than a predetermined second threshold (that is, the detection performance of the first data processing model converges). For another example, the preset stop condition may alternatively be: the number of updates of the first data processing model reaching a predetermined third threshold.

The detection loss of the first data processing model is used to represent the detection performance of the first data processing model (for example, detection performance for a detection box, or detection performance for a detection box and class detection performance). In addition, the present disclosure does not limit a process of determining the detection loss. For example, the process may specifically include: determining a detection loss for a detection box of the first data processing model based on the detection box prediction result corresponding to the image to be used and a detection box label corresponding to the image to be used; and determining the detection loss of the first data processing model based on the detection loss for the detection box.

In addition, the present disclosure does not limit a process of determining the “detection loss for a detection box of the first data processing model” in the above paragraph. For example, the process may be implemented by using the following formula (7).

$${ℒ}_{DE} = {L}_{𝒟 et} ( y , \hat{y} ) \qquad ( 7 )$$

In the formula, [symbol] _{DE} represents the detection loss for a detection box of the first data processing model. y represents the detection box label corresponding to the foregoing image to be used. ŷ represents the detection box prediction result corresponding to the foregoing image to be used. [symbol] _{Det}(y, ŷ) represents a difference between the detection box prediction result corresponding to the image to be used and the detection box label corresponding to the image to be used. In addition, the present disclosure does not limit an implementation of [symbol] _{Det}(⋅), and it may be set according to a specific application scenario (for example, a detection framework used by the foregoing second detection network). This is not specifically limited in the present disclosure.

Based on the related content of the foregoing step 313, it can be learned that for the first data processing model involved in the current training process, it may be determined whether the first data processing model has satisfied the preset stop condition that is set in advance. When the first data processing model has satisfied the preset stop condition, it may be determined that the first data processing model has a good detection performance for a detection box, and then it may be determined that the second detection network in the first data processing model has a good detection performance for a detection box for the feature maps provided by the second diffusion model. Therefore, the training process of the first data processing model may end, and the following step 32 is performed. However, when the first data processing model does not satisfy the preset stop condition, it may be determined that the detection performance for a detection box of the first data processing model still needs to be improved, and therefore the following step 314 may be performed.

Step 314: when the preset stop condition is not satisfied, updating the second detection network in the first data processing model based on the detection box prediction result corresponding to the image to be used and a detection box label corresponding to the image to be used, and return to the foregoing step 311 and its subsequent steps.

In the present disclosure, for the first data processing model involved in the current round of training process, when it is determined that the first data processing model does not satisfy the preset stop condition, it may be determined that the detection performance for a detection box of the first data processing model still needs to be improved. In this case, the second detection network in the first data processing model may be updated directly based on the difference between the detection box prediction result corresponding to the image to be used and the detection box label corresponding to the image to be used, so that an updated second detection network has a better detection performance for a detection box for the feature maps provided by the foregoing second diffusion model; and the foregoing step 311 and its subsequent steps are performed based on a first data processing model including the updated second detection network, to implement a new round of training process for the first data processing model. The training process of the first data processing model ends when the preset stop condition is satisfied after such iterative loops.

It should be noted that in some application scenarios, when the second diffusion model in the foregoing first data processing model is determined based on the first diffusion model that has been constructed, the first diffusion model has a good image generation function, so that the second diffusion model also has a good image generation function. Therefore, to better improve the performance of the second detection network in the first data processing model, only a parameter in the foregoing second detection network may be updated during the updating of the first data processing model, and a parameter of the second diffusion model does not need to be updated. In this way, the second detection network can learn, from the training process of the first data processing model, how to better align implicit semantics and position knowledge in the first diffusion model with a detection perception signal, to predict a detection box, so that a final second detection network obtained through learning has a better detection performance for a detection box for the feature maps provided by the first diffusion model.

Based on the related content of the foregoing step 311 to step 314, it can be learned that the training process of the foregoing first data processing model may be implemented through one-step noise addition and noise reduction process, so that the training process has the following three advantages (1) to (3).

(1) Because the first data processing model performs the noise addition process and noise reduction process for only a small number of time steps (for example, noise addition process for one time step and noise reduction process for one time step), impact of the conditional signal (for example, the foregoing condition prompt text) on the feature map generated by the second diffusion model in the first data processing model is negligible. Therefore, the conditional signal has little impact on the training process of the first data processing model, and it may be determined that whether to use the condition prompt text aligned with the image data in the training process has little impact on the training process. Therefore, to reduce the training difficulty, the first data processing model may be trained by using only image data and a detection annotation corresponding to the image data (that is, the foregoing detection box label). In this way, a dataset without image description texts (for example, the image description text “A cow in the grass” shown in FIG. 2) can be used during the training process of the first data processing model, which can effectively reduce the difficulty in obtaining the training data used in the training process.

(2) Because the first data processing model performs the noise addition process and noise reduction process for only a small number of time steps (for example, noise addition process for one time step and noise reduction process for one time step), the layout and composition of the input data of the first data processing model (that is, the original image) are well preserved. Therefore, reliability of an original annotation of the input data (that is, the detection box label corresponding to the original image) is ensured.

(3) Because the training process of the first data processing model needs to be implemented based only on the image data and the detection annotation corresponding to the image data, any existing or future annotated detection dataset can be used directly for the training process of the first data processing model, without additional data collection and annotation operations. Therefore, the costs of constructing the first data processing model can be effectively reduced.

It should be noted that for the foregoing step 31, in some application scenarios (for example, target detection scenarios), to better improve the detection performance of a trained first data processing model, the present disclosure further provides a possible implementation of the foregoing step 31, which may be specifically: training the first data processing model by using the plurality of third images, the detection box label corresponding to each third image, and a class label corresponding to each third image, so that the trained first data processing model not only has a good detection performance for a detection box, but also has a good class detection performance. The class label is used to indicate a class to which a target in the third image actually belongs.

It should be further noted that the present disclosure does not limit an implementation of the step of “training the first data processing model by using the plurality of third images, the detection box label corresponding to each third image, and a class label corresponding to each third image” in the above paragraph. For example, the implementation is similar to the implementation provided for the foregoing step 31. For brevity, details are not described herein again.

Step 32: determining the first detection network based on a second detection network in the trained first data processing model.

It should be noted that the present disclosure does not limit an implementation of step 32. For example, the implementation may be specifically: directly determining the second detection network (for example, a detection network 2 shown in FIG. 2) in the trained first data processing model as the first detection network (for example, a detection network 1 shown in FIG. 2).

Based on the related content of the foregoing step 31 and step 32, it can be learned that in a possible implementation, the first detection network may be constructed through the training process of the first data processing model including the second diffusion model and the second detection network. In this way, the constructed first detection network can learn, from the training process of the first data processing model, how to better align implicit semantics and position knowledge in the first diffusion model with the detection perception signal, to predict the detection box (and the target class), so that the constructed first detection network has a better detection performance for a detection box (and class detection performance) for the feature map provided by the foregoing first diffusion model. Therefore, the first detection network can be subsequently used to process at least one feature map corresponding to an image two-tuple, to obtain a target detection box (and a target class) corresponding to the image data.

In fact, in some application scenarios (for example, target detection scenarios), the foregoing S103 may be specifically: determining, based on the foregoing at least one feature map, the target detection box corresponding to the second image and the target class corresponding to the second image. The target class is used to represent the class to which at least one target in the second image belongs.

It should be noted that an implementation of the step of “determining, based on the foregoing at least one feature map, the target detection box corresponding to the second image and the target class corresponding to the second image” in the content of the above paragraph is similar to the implementation of S103 shown above. For brevity, details are not described herein again.

Based on the related content of the foregoing S103, it can be learned that in a possible implementation, after the at least one feature map corresponding to the foregoing second image is obtained, the feature map(s) may be detected by using the pre-constructed first detection network, to obtain and output the target detection box and the target class that correspond to the second image, so that the detection box can represent the position of the at least one target (for example, the cow) in the second image, and the target class represents the class to which the at least one target in the second image belongs (for example, the class “cow” shown in FIG. 2). The second image, and the target detection box and the target class that correspond to the second image are determined based on the feature map(s), so that image feature information (for example, implicit semantics and position knowledge involved in the first diffusion model) referenced in the process of determining the second image is consistent with image feature information referenced in the process of determining the target detection box and the target class that correspond to the second image. In this way, the target detection box can more accurately represent the position, in the second image, of the at least one target in the second image, and the target class can more accurately represent the class to which the at least one target in the second image belongs. Therefore, the data quality of the two-tuple <the second image, the target detection box corresponding to the second image> can be effectively improved, and the data quality of the training data determined based on the two-tuple can be improved.

S104: determining training data based on the second image and the target detection box corresponding to the second image.

In the present disclosure, in a possible implementation, after the second image and the target detection box corresponding to the second image are obtained, the training data may be determined by using the two-tuple <the second image, the target detection box corresponding to the second image>, so that the training data includes the two-tuple <the second image, the target detection box corresponding to the second image>.

In addition, the present disclosure does not limit an implementation of the foregoing S104. For example, the implementation may be specifically: determining the two-tuple <the second image, the target detection box corresponding to the second image> as one piece of training data. For another example, in some application scenarios (for example, augmentation of training data), when the foregoing training dataset includes the two-tuple <the first image, the target detection box label corresponding to the first image>, S104 may be specifically: updating the training dataset by using the second image and the target detection box corresponding to the second image, so that an updated training dataset includes not only the training data <the first image, the target detection box label corresponding to the first image>, but also includes the training data <the second image, the target detection box corresponding to the second image>. Because there is a difference between the first image and the second image, the updated training dataset has more diverse image data, which helps improve the diversity of the training data.

In fact, to better improve the data quality of the training data, the present disclosure further provides a possible implementation of the foregoing S104. For example, S104 may specifically include the following step 41 and step 42.

Step 41: After at least one detection box corresponding to the second image and a prediction confidence of each detection box are determined based on the at least one feature map corresponding to the second image, determining, from the at least one detection box based on the prediction confidence of each detection box, a detection box satisfying a preset confidence condition.

The prediction confidence of a detection box is used to represent a degree of accuracy of the detection box. In addition, the present disclosure does not limit a manner of obtaining the prediction confidence of the detection box. For example, the manner may be specifically: processing, by using a pre-constructed first detection network, the at least one feature map corresponding to the foregoing second image, to obtain the at least one detection box corresponding to the second image and the prediction confidence of each detection box.

The preset confidence condition is a condition required for filtering a plurality of detection boxes that are obtained through prediction for an image two-tuple. In addition, the present disclosure does not limit the preset confidence condition. For example, the preset confidence condition may be specifically: the prediction confidence being greater than a preset threshold (for example, 0.3).

Based on the related content of the foregoing step 41, it can be learned that after the at least one detection box corresponding to the second image and the prediction confidence of each detection box are obtained, detection boxes with high prediction confidences are selected from the detection boxes based on the prediction confidences, so that a two-tuple including the second image can be generated subsequently based on the detection boxes with high prediction confidences, which helps improve the data quality of the two-tuple.

Step 42: determining the training data based on the second image and the foregoing detection box satisfying the preset confidence condition.

In the present disclosure, after the second image and the foregoing detection box satisfying the preset confidence condition are obtained, the training data may be determined by using a two-tuple <the second image, the detection box satisfying the preset confidence condition>, so that the training data includes the second image and the detection box satisfying the preset confidence condition (for example, the training data is the two-tuple <the second image, the detection box satisfying the preset confidence condition>), which helps improve the data quality of the training data.

Based on the related content of the foregoing step 41 and step 42, it can be learned that after the at least one detection box corresponding to the second image and the prediction confidence of each detection box are obtained, the detection boxes with high prediction confidences may be selected from the detection boxes based on the prediction confidences, and then the training data may be determined based on the second image and the detection boxes with high prediction confidences, so that the training data includes more accurate detection boxes, which helps improve the data quality of the training data.

In fact, in some application scenarios (for example, when the target detection box corresponding to the second image and the target class corresponding to the second image are determined in the foregoing S103), the foregoing S104 may be specifically: determining the training data based on the second image, the target detection box corresponding to the second image, and the target class corresponding to the second image, so that the training data includes the second image, the target detection box corresponding to the second image, and the target class corresponding to the second image.

It should be noted that an implementation of the step of “determining the training data based on the second image, the target detection box corresponding to the second image, and the target class corresponding to the second image” in the content of the above paragraph is similar to the implementation of the foregoing S104. For brevity, details are not described herein again.

Based on the related content of the foregoing S101 to S104, it can be learned that for the training data determination method provided by the embodiments of the present disclosure, the first image (for example, a piece of image data present in the training data) is first obtained. Then, an image generation process is performed on the first image, to obtain the at least one feature map (for example, a plurality of feature maps of different sizes) and the second image, the second image is determined based on the at least one feature map, and the at least one feature map is determined based on the first image. Next, the target detection box corresponding to the second image is determined based on the at least one feature map, so that the target detection box can represent the position, in the second image, of the at least one target (for example, a physical object or an animal) in the second image. Finally, the training data is determined based on the second image and the target detection box corresponding to the second image (for example, the two-tuple <the second image, the target detection box corresponding to the second image> is determined as the training data). In this way, new training data can be automatically generated based on some existing images, so that an increase in annotation costs caused by manual annotation for detection boxes can be effectively avoided, and difficulty in obtaining the training data can be reduced while ensuring data quality of the training data.

In addition, both the second image and the target detection box corresponding to the second image are determined based on the at least one feature map, so that the image feature information (for example, the implicit semantics and the position knowledge involved in the first diffusion model) referenced in the process of determining the second image is consistent with the image feature information referenced in the process of determining the target detection box corresponding to the second image. In this way, the target detection box can more accurately represent the position, in the second image, of the at least one target in the second image. Therefore, the data quality of the two-tuple <the second image, the target detection box corresponding to the second image> can be effectively improved, which helps improve the data quality of the training data determined based on the two-tuple, thereby improving the data quality of the training data.

In addition, in some possible implementations, because the second image is generated based on the image generation constraint information corresponding to the foregoing first image (for example, the image description text “A cow in the grass”), the second image has a certain difference from the foregoing first image. In this way, the diversity of image data can be improved while ensuring the generation of a reasonable image, so that richness of the training data can be improved while ensuring the data quality of the training data, and the detection performance of the target detection model trained based on the training data can be improved.

Further, the present disclosure does not limit an execution body of the foregoing training data determination method. For example, the training data determination method provided by the embodiments of the present disclosure may be applied to a device having a data processing function, such as a terminal device or a server. For another example, the training data determination method provided by the embodiments of the present disclosure may alternatively be implemented based on a data communication process between different devices (for example, a terminal device and a server, two terminal devices, or two servers). The terminal device may be a smartphone, a computer, a personal digital assistant (PDA), a tablet, etc. The server may be a stand-alone server, a cluster server, or a cloud server.

In fact, to better improve the quality of the training data, the present disclosure further provides a possible implementation of the foregoing training data determination method, which may specifically include the following step 51 to step 52.

Step 51: obtaining a first image.

It should be noted that for related content of the foregoing step 51, refer to the related content of the foregoing step 101. For brevity, details are not described herein again.

Step 52: determining, by using a pre-constructed second data processing model and the first image, a second image and a target detection box corresponding to the second image, in which the second data processing model includes a first diffusion model and a first detection network; the first diffusion model is used to perform an image generation process on the first image, to obtain at least one feature map and the second image; and the first detection network is used to determine, based on the at least one feature map, the target detection box corresponding to the second image (or the target detection box corresponding to the second image and a target class corresponding to the second image).

The second data processing model is used to perform a data generation process on input data of the second data processing model. For example, the second data processing model may be a diffusion engine including M denoising sub-modules shown in FIG. 2.

In addition, the second data processing model may include a first diffusion model and a first detection network, and input data of the first detection network includes a feature map generated during the last noise reduction process in the first diffusion model. For related content of the first diffusion model and the first detection network, refer to the foregoing descriptions.

In addition, the present disclosure does not limit a construction process of the foregoing second data processing model. For example, the process may specifically include the following step 61 to step 63.

Step 61: constructing the first diffusion model, so that the constructed first diffusion model has a good image generation function.

It should be noted that the present disclosure does not limit an implementation of step 61. For example, step 61 may be implemented by using any existing or future method that can be used to construct a diffusion model with an image generation function.

Step 62: constructing the foregoing first data processing model (for example, the diffusion engine including one denoising sub-module shown in FIG. 2) based on the constructed first diffusion model, so that the first data processing model includes the second diffusion model and the second detection network, a parameter in the second diffusion model is not updated during a training process of the first data processing model.

In the present disclosure, in a possible implementation, after the constructed first diffusion model is obtained, the second diffusion model is constructed based on the constructed first diffusion model, so that the second diffusion model includes all or part of the first diffusion model; and then the second diffusion model is combined with a second detection network requiring learning training, to obtain a first data processing model that needs to be trained.

Step 63: training the first data processing model by using a plurality of third images and a detection box label corresponding to each third image (or by using a plurality of third images, a detection box label corresponding to each third image, and a class label corresponding to each third image).

It should be noted that for related content of the foregoing step 63, refer to the related content of the foregoing step 31. For brevity, details are not described herein again.

Step 64: updating the foregoing trained first data processing model by using the constructed first diffusion model, to obtain a second data processing model, so that the second data processing model includes the constructed first diffusion model and the first detection network that is determined based on the trained second detection network.

In the present disclosure, after the trained first data processing model is obtained, a module for implementing a noise addition function and a module for implementing a noise reduction function in the first data processing model may be respectively replaced with a noise addition module and a denoising module in the above constructed first diffusion model, to obtain the second data processing model, so that the second data processing model includes not only the noise addition module and the denoising module in the first diffusion model, but also other module(s) in the first data processing model other than the module for implementing the noise addition function and the module for implementing the noise reduction function, which helps improve a data generation function of the second data processing model.

Based on the related content of the foregoing step 61 to step 64, it can be learned that in some application scenarios, the construction process of the second data processing model may be completed through two-phase training, so that all modules in the second data processing model have better coordination, and the second data processing model has a better data generation function.

In addition, the present disclosure does not limit an operating principle of the foregoing second data processing model. For example, when the second data processing model is the diffusion engine including M denoising sub-modules shown in FIG. 2, for the operating principle of this second data processing model, refer to the process of generating the image 2 and the detection box of the image 2 in FIG. 2.

Based on the related content of the foregoing step 51 and step 52, it can be learned that in some application scenarios, after the first image and the image generation constraint information corresponding to the first image are obtained, the two pieces of information may be processed by using a constructed model (that is, the second data processing model), to obtain the second image and the target detection box (and the target class) corresponding to the second image. Because of good coordination between different modules in the model, there is a better match between the second image and the target detection box corresponding to the second image, which are output by the model. This helps improve data quality of a two-tuple <the second image, the target detection box corresponding to the second image> (or a triplet <the second image, the target detection box corresponding to the second image, the target class corresponding to the second image>), thereby improving data quality of training data that includes the two-tuple.

It has been found in research that for the foregoing first diffusion model, the first diffusion model may generate a large amount of image data that differs from a reference image (for example, the image 1 shown in FIG. 2) to different extents by adjusting constraint information such as the random seed, the encoding rate, the guidance scale, or the condition prompt text. Therefore, to better improve richness of the training data, the present disclosure further provides a possible implementation of the foregoing training data determination method, which may specifically include the following step 71 to step 77.

Step 71: determining a first image from a training dataset, and obtain image generation constraint information corresponding to the first image.

The training data is a dataset that needs to be augmented. In addition, the present disclosure does not limit the training dataset. For example, the training dataset may include at least the image 1 shown in FIG. 2 and a target detection box label corresponding to the image 1.

Further, for related content of the first image and the image generation constraint information corresponding to the first image, refer to the related content of the foregoing S101 and S102. For brevity, details are not described herein again.

In addition, the present disclosure does not limit a manner of obtaining the foregoing first image. For example, the manner may be specifically: randomly selecting a piece of image data from all original images in the training data that are not traversed as the first image.

Step 72: performing an image generation process on the first image based on the image generation constraint information corresponding to the first image, to obtain at least one feature map and a second image, in which the second image is determined based on the at least one feature map, and the at least one feature map is determined based on the first image and the image generation constraint information.

It should be noted that for related content of the foregoing step 72, refer to the related content of the foregoing step 102. For brevity, details are not described herein again.

Step 73: determining, based on the foregoing at least one feature map, a target detection box (and a target class) corresponding to the second image.

It should be noted that for related content of the foregoing step 73, refer to the related content of the foregoing S103. For brevity, details are not described herein again.

Step 74: updating the training dataset based on the second image and the target detection box (and the target class) corresponding to the second image, so that an updated training dataset includes the second image and the target detection box (and the target class) corresponding to the second image.

In the present disclosure, after the second image and the target detection box corresponding to the second image are obtained, the training dataset may be updated by using a two-tuple <the second image, the target detection box corresponding to the second image> (or a triplet <the second image, the target detection box corresponding to the second image, the target class corresponding to the second image>) as a piece of new training data, so that the updated training dataset includes the two-tuple <the second image, the target detection box corresponding to the second image> (or the triplet <the second image, the target detection box corresponding to the second image, the target class corresponding to the second image>).

Step 75: determining whether a first end condition is satisfied. When the first end condition is satisfied, the following step 77 is performed; or when the first end condition is not satisfied, the following step 76 is performed.

The first end condition is a condition required when a plurality processes of generating images based on the first image end. In addition, the present disclosure does not limit the first end condition. For example, the first end condition may be specifically: a predetermined number of image generation iterations for the first image being reached.

Based on the related content of the foregoing step 75, it can be learned that for a current image generation process, when it is determined that the first end condition is satisfied, it may be determined that enough new images and their corresponding target detection boxes (and target classes) have been generated by using the first image, and therefore the following step 77 may be performed directly; or when it is determined that the first end condition is not satisfied, it may be determined that a new image and its corresponding target detection box (and target class) still need to be generated by using the first image, and therefore the following step 76 may be performed directly.

Step 76: when the first end condition is not satisfied, adjusting part or all of constraint items in the image generation constraint information corresponding to the first image, and returning to the foregoing step 72 and its subsequent steps.

A constraint item is a piece of information that is present in the image generation constraint information corresponding to the foregoing first image and that has a constraint function for the image generation process. For example, the constraint item may be the foregoing random seed, encoding rate, guidance scale, or condition prompt text.

Based on the related content of the foregoing step 76, it can be learned that for the current round of image generation process, when it is determined that the first end condition is not satisfied, it may be determined that a new image and its corresponding target detection box (and target class) still need to be generated by using the first image. In this case, part or all of the constraint items in the image generation constraint information corresponding to the first image may be adjusted (for example, at least one of a group consisting of the random seed, the encoding rate, the guidance scale, and the condition prompt text is adjusted), so that image generation constraint information after constraint item adjusting differs from the image generation constraint information used in a historical image generation process that is based on the first image, and the foregoing step 72 and its subsequent steps can be performed subsequently based on the “image generation constraint information after constraint item adjusting”. In this way, a new round of image generation process for the first image can be implemented. The following step 77 may be performed when the first end condition is satisfied after such iterative loops.

Step 77: when the first end condition is satisfied, determining whether a second end condition is satisfied. When the second end condition is satisfied, an augmentation process for the training data ends; or when the second end condition is not satisfied, returning to the foregoing step 71 and its subsequent steps.

The second end condition is a condition required for ending the augmentation process for the foregoing training data. In addition, the present disclosure does not limit the second end condition. For example, the second end condition may be specifically: all original images present in the training data being traversed.

Based on the related content of the foregoing step 77, it can be learned that for the current round of image generation process, when it is determined that the first end condition is satisfied, it may be determined that enough new images and their corresponding target detection boxes (and target classes) have been generated by using the first image. Therefore, it may be further determined whether the second end condition is satisfied. When the second end condition is satisfied, it may be determined that a plurality of image generation processes for all the original images in the training data have been completed, so that the augmentation process for the training data can directly end; or when the second end condition is not satisfied, it may be determined that there is still an original image in the training data that is not traversed, so that the foregoing step 71 and its subsequent steps may be continuously performed, and the augmentation process for the training data can end when the second end condition is satisfied after such iterative loops.

Based on the related content of the foregoing step 71 to step 77, it can be learned that for the augmentation process of the training data, the random seed, the encoding rate, the guidance scale, and the condition prompt text may be adjusted for a plurality of times to generate a large amount of image data that differs from each original image in the training data, and detection boxes (and target classes) of the image data. In this way, richness of the training data can be effectively improved, which helps improve the effect of augmentation of the training data.

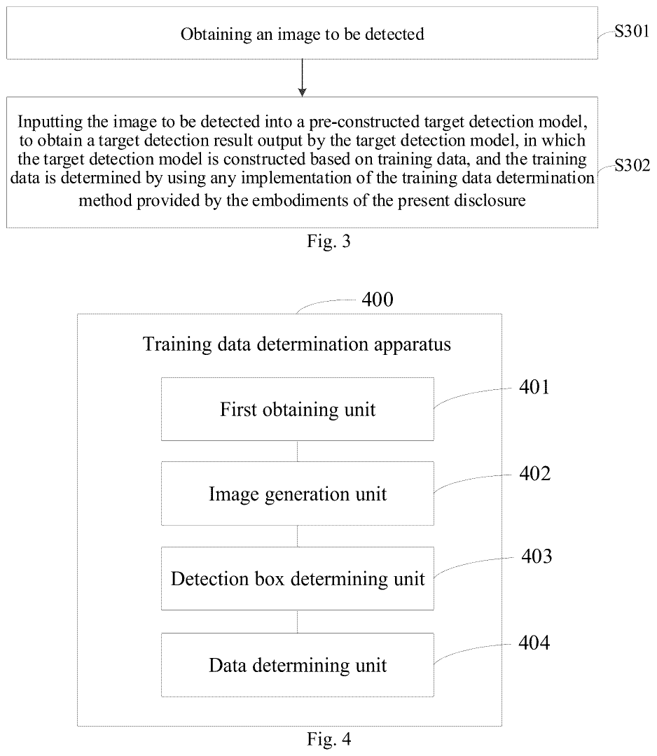

Based on the related content of the foregoing training data determination method, the present disclosure further provides a target detection method. For ease of understanding, the target detection method is described below with reference to FIG. 3. As shown in FIG. 3, a target detection method provided by the embodiments of the present disclosure includes the following S301 and S302. FIG. 3 is a flowchart of a target detection method provided by the embodiments of the present disclosure.

S301: obtaining an image to be detected.

The image to be detected is image data that requires target detection. In addition, the present disclosure does not limit the image to be detected.

S302: inputting the image to be detected into a pre-constructed target detection model, to obtain a target detection result output by the target detection model, in which the target detection model is constructed based on training data, and the training data is determined by using any implementation of the training data determination method provided by the embodiments of the present disclosure.

The target detection model is used to perform a target detection process on input data of the target detection model. In addition, the present disclosure does not limit an implementation of the target detection model. For example, the target detection model may be implemented by using any existing or future model with a target detection function (for example, the target detection model).

In addition, the target detection model is constructed based on the foregoing training data, and the training data is determined by using any implementation of the training data determination method provided by the present disclosure, so that the training data includes at least the foregoing second image and the target detection box (and the target class) corresponding to the second image.

The target detection result is used to indicate a type of a target that is present in the foregoing image to be detected and a position of the target in the image to be detected.

Based on the related content of the foregoing S301 and S302, it can be learned that after augmented training data in an application field is obtained, a target detection model in the field is first trained by using the training data, to obtain a trained target detection model, so that the target detection model has a good target detection performance. In this way, after the image to be detected is input into the pre-constructed target detection model, the target detection model performs the target detection process on the image to be detected, to obtain and output the target detection result corresponding to the image to be detected, so that the target detection result can indicate the type of the target that is present in the image to be detected and the position of the target in the image to be detected. Because the training data has high richness and data quality, the target detection model trained based on the training data also has a good target detection performance. Therefore, the target detection result determined by using the target detection model can more accurately represent the type of the target that is present in the image to be detected and the position of the target in the image to be detected, which helps improve the effect of target detection in this field.

In addition, the present disclosure does not limit an execution body of the foregoing target detection method. For example, the target detection method provided by the embodiments of the present disclosure may be applied to a device having a data processing function, such as a terminal device or a server. For another example, the target detection method provided by the embodiments of the present disclosure may alternatively be implemented based on a data communication process between different devices (for example, a terminal device and a server, two terminal devices, or two servers).

Based on the training data determination method provided by the embodiments of the present disclosure, the embodiments of the present disclosure further provide a training data determination apparatus. The following provides explanations and descriptions with reference to FIG. 4. FIG. 4 is a schematic diagram of a structure of a training data determination apparatus provided by the embodiments of the present disclosure. It should be noted that for the technical details of the training data determination apparatus provided by the embodiments of the present disclosure, refer to the related content of the foregoing training data determination method.

As shown in FIG. 4, the training data determination apparatus 400 provided by the embodiments of the present disclosure includes:

a first obtaining unit 401, configured to obtain a first image;

an image generation unit 402, configured to perform an image generation process on the first image, to obtain at least one feature map and a second image, in which the second image is determined based on the at least one feature map, and the at least one feature map is determined based on the first image;

a detection box determining unit 403, configured to determine, based on the at least one feature map, a target detection box corresponding to the second image; and

a data determining unit 404, configured to determine training data based on the second image and the target detection box corresponding to the second image.

In a possible implementation, the first obtaining unit 401 is specifically configured to obtain image generation constraint information corresponding to the first image; and

the image generation unit 402 is specifically configured to perform the image generation process on the first image based on the image generation constraint information, to obtain the at least one feature map and the second image, in which the at least one feature map is determined based on the first image and the image generation constraint information.

In a possible implementation, the image generation unit 402 is specifically configured to determine the at least one feature map and the second image by using a pre-constructed first diffusion model, the image generation constraint information, and the first image.

In a possible implementation, the image generation constraint information includes a condition prompt text; and

the image generation unit 402 is specifically configured to: perform feature extraction on the condition prompt text, to obtain a condition prompt feature; and input the condition prompt feature and the first image into the first diffusion model, to obtain the at least one feature map and the second image.

In a possible implementation, the first diffusion model includes a denoising module and a decoding module, the denoising module is used to perform a plurality of noise reduction processes on input data of the denoising module, and input data of the decoding module includes a processing result of the last noise reduction process; the at least one feature map is determined based on an intermediate feature generated during the last noise reduction process; and the second image is determined based on output data of the decoding module.

In a possible implementation, the image generation constraint information includes at least one of a group consisting of a random seed, an encoding rate, a guidance scale, or a condition prompt text.

In a possible implementation, the training data determining apparatus 400 further includes:

a constraint adjustment unit, configured to: after the training data is determined based on the second image and the target detection box corresponding to the second image, adjust part or all of constraint items in the image generation constraint information, and continue to perform the step of performing the image generation process on the first image based on the image generation constraint information, to obtain the at least one feature map and the second image, until a first end condition is satisfied.

In a possible implementation, the first obtaining unit 401 is specifically configured to determine the first image from a training dataset;

the data determining unit 404 is specifically configured to update the training dataset by using the second image and the target detection box corresponding to the second image; and

the training data determining apparatus 400 further includes:

an iteration unit, configured to: when the first end condition is satisfied, return to the step that the first obtaining unit 401 determines the first image from a training dataset, until a second end condition is satisfied.

In a possible implementation, the detection box determining unit 403 is specifically configured to process the at least one feature map by using a pre-constructed first detection network, to obtain the target detection box corresponding to the second image.

In a possible implementation, a construction process of the first detection network includes:

training a first data processing model by using a plurality of third images and a detection box label corresponding to each third image, in which the first data processing model includes a second diffusion model and a second detection network, and a parameter in the second diffusion model is not updated during a training process of the first data processing model; and determining the first detection network based on a second detection network in a trained first data processing model.

In a possible implementation, the second image is generated by using a pre-constructed first diffusion model; and the second diffusion model is determined based on the first diffusion model.

In a possible implementation, the second image is generated by using a pre-constructed first diffusion model; the first diffusion model is used to perform a first number of noise addition processes and a first number of noise reduction processes; and the second diffusion model is to perform a second number of noise addition processes and a second number of noise reduction processes, the second number is less than the first number.

In a possible implementation, the training process of the first data processing model includes: determining an image to be used from the plurality of third images; inputting the image to be used into the first data processing model, to obtain a detection box prediction result that corresponds to the image to be used and that is output by the first data processing model; and updating the second detection network in the first data processing model based on the detection box prediction result and the detection box label, and continuing to perform the step of determining an image to be used from the plurality of third images, until a preset stop condition is satisfied.

In a possible implementation, the detection box prediction result is determined by the second detection network through processing at least one feature map corresponding to the image to be used, and the at least one feature map corresponding to the image to be used is determined by the second diffusion model through processing the image to be used.

In a possible implementation, the at least one feature map includes a plurality of feature maps, sizes of different feature maps are different; and

the detection box determining unit 403 is specifically configured to: construct a pyramid feature by using the plurality of feature maps; and input the pyramid feature into the first detection network, to obtain the target detection box corresponding to the second image.

In a possible implementation, the training data determining apparatus 400 includes a data generation unit including the detection box determining unit 403 and the data determining unit 404.

The data generation unit is configured to determine, by using a pre-constructed second data processing model and the first image, the second image and the target detection box corresponding to the second image, in which the second data processing model includes a first diffusion model and a first detection network; the first diffusion model is used to perform the image generation process on the first image, to obtain the at least one feature map and the second image; and the first detection network is used to determine, based on the at least one feature map, the target detection box corresponding to the second image.

Based on the related content of the foregoing training data determining apparatus 400, it can be learned that the training data determination apparatus 400 provided by the embodiments of the present disclosure first obtains the first image (for example, a piece of image data present in the training data); then, performs the image generation process on the first image, to obtain the at least one feature map (for example, a plurality of feature maps of different sizes) and the second image, in which the second image is determined based on the at least one feature map, and the at least one feature map is determined based on the first image; next, determines, based on the at least one feature map, the target detection box corresponding to the second image, so that the target detection box can represent the position, in the second image, of the at least one target (for example, a physical object or an animal) in the second image; and finally, determines the training data based on the second image and the target detection box corresponding to the second image (for example, determines a two-tuple <the second image, the target detection box corresponding to the second image> as the training data). In this way, new training data can be automatically generated based on some existing images, thereby effectively avoiding an increase in annotation costs caused by manual annotation for detection boxes, and reducing difficulty in obtaining the training data while ensuring the data quality of the training data.

In addition, both the second image and the target detection box corresponding to the second image are determined based on the at least one feature map, so that image feature information (for example, implicit semantics and position knowledge involved in the first diffusion model) referenced in a process of determining the second image is consistent with image feature information referenced in a process of determining the target detection box corresponding to the second image. In this way, the target detection box can more accurately represent the position, in the second image, of the at least one target in the second image. Therefore, the data quality of the two-tuple <the second image, the target detection box corresponding to the second image> can be effectively improved, which helps improve the data quality of the training data determined based on the two-tuple, thereby improving the data quality of the training data.

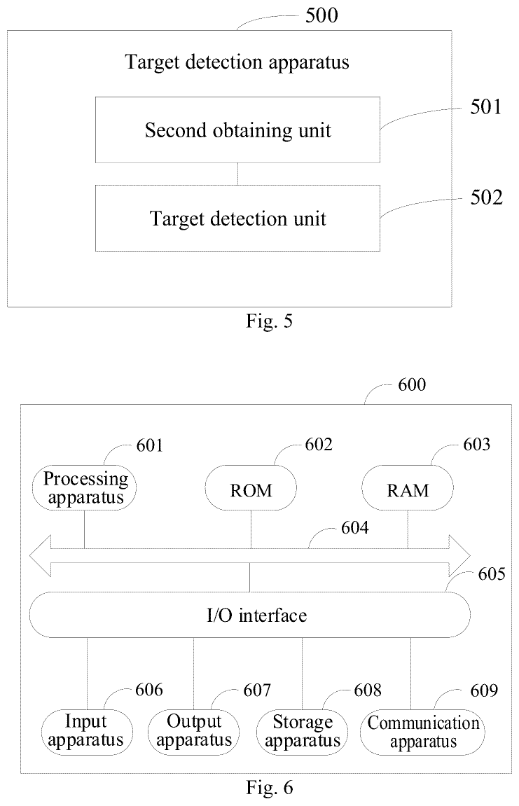

Based on the target detection method provided by the embodiments of the present disclosure, the embodiments of the present disclosure further provide a target detection apparatus. The following provides explanations and descriptions with reference to FIG. 5. FIG. 5 is a schematic diagram of a structure of a target detection apparatus provided by the embodiments of the present disclosure. It should be noted that for the technical details of the target detection apparatus provided by the embodiments of the present disclosure, refer to the related content of the foregoing target detection method.

As shown in FIG. 5, the target detection apparatus 500 provided by the embodiments of the present disclosure includes:
a second obtaining unit 501, configured to obtain an image to be detected; and
a target detection unit 502, configured to input the image to be detected into a pre-constructed target detection model, to obtain a target detection result output by the target detection model, in which the target detection model is constructed based on training data; and the training data is determined by using any implementation of the training data determination method provided by the embodiments of the present disclosure.

Based on the related content of the target detection apparatus 500, it can be learned that the target detection apparatus 500 provided by the embodiments of the present disclosure first trains, after obtaining augmented training data in an application field, a target detection model in the field by using the training data, to obtain a trained target detection model, so that the target detection model has a good target detection performance. In this way, after the image to be detected is input into the pre-constructed target detection model, the target detection model performs the target detection process on the image to be detected, to obtain and output the target detection result corresponding to the image to be detected, so that the target detection result can indicate a type of a target that is present in the image to be detected and a position of the target in the image to be detected. Because the training data has high richness and data quality, the target detection model trained based on the training data also has good target detection performance. Therefore, the target detection result determined by using the target detection model can more accurately represent the type of the target that is present in the image to be detected and the position of the target in the image to be detected, which helps improve the effect of target detection in this field.

In addition, the embodiments of the present disclosure further provide an electronic device. The device includes a processor and a memory, the memory is configured to store instructions or a computer program; and the processor is configured to execute the instructions or computer program in the memory, to cause the electronic device to perform any implementation of the training data determination method according to the embodiments of the present disclosure, or perform any implementation of the target detection method according to the embodiments of the present disclosure.

Referring to FIG. 6, which is a schematic diagram of a structure of an electronic device 600 suitable for implementing the embodiments of the present disclosure. The terminal device in the embodiments of the present disclosure may include but is not limited to mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (for example, a central processor or a graphics processor) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to one another through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to the embodiments of the present disclosure, the process described above with reference to the flowchart may be implemented as a computer software program. For example, the embodiments of the present disclosure provide a computer program product, which includes a computer program carried on a non-transitory computer-readable medium, the computer program includes program codes for performing the method shown in the flowchart. In such embodiments, the computer program may be downloaded and installed from a network through the communication apparatus 609, installed from the storage apparatus 608, or installed from the ROM 602. When the computer program is executed by the processing apparatus 601, the above-mentioned functions defined in the method of the embodiments of the present disclosure are performed.

The electronic device according to the embodiments of the present disclosure and the method according to the foregoing embodiments belong to the same inventive concept. For the technical details not exhaustively described in this embodiment, reference may be made to the foregoing embodiments, and this embodiment and the foregoing embodiments have the same beneficial effects.

The embodiments of the present disclosure further provide a computer-readable medium having instructions or a computer program stored therein, the instructions or the computer program, when run on a device, causes the device to perform any implementation of the training data determination method according to the embodiments of the present disclosure, or perform any implementation of the target detection method according to the embodiments of the present disclosure.

It should be noted that the foregoing computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may alternatively be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The foregoing computer-readable medium may be contained in the foregoing electronic device. Alternatively, the computer-readable medium may exist independently, without being assembled into the electronic device.

The foregoing computer-readable medium carries one or more programs that, when executed by the electronic device, cause the electronic device to perform the foregoing method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any type of network, including a local area network (LAN) or a wide area network (WAN), or may be connected to an external computer (for example, connected through the Internet with the help of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram can represent a module, program segment, or a part of code, and the module, program segment, or a part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), etc.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in the present disclosure are described in a progressive manner, and each embodiment focuses on the differences from other embodiments. The same or similar parts between the various embodiments may be referenced to each other. For the system or apparatus disclosed in the embodiments, since it corresponds to the method disclosed in the embodiments, the description is simple, and for the related parts, reference may be made to the description of the method.

It should be understood that, in the present disclosure, “at least one” means one or more, and “a plurality of” means two or more. The term “and/or” is used to describe an association relationship between associated objects, and indicates that three relationships may exist, for example, A and/or B may indicate the following three cases: Only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, and c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. In addition, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The steps of the method or algorithm described with reference to the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the foregoing description of the disclosed embodiments, persons skilled in the art could implement or use the present disclosure. Various modifications to these embodiments are apparent to persons skilled in the art, and the general principle defined herein may be practiced in other embodiments without departing from the spirit or scope of the present disclosure. Therefore, the present disclosure is not be limited to the embodiments shown herein, but extends to the widest scope that complies with the principles and novelty disclosed in the present disclosure.

1. A training data determination method, comprising:
obtaining a first image;
performing an image generation process on the first image, to obtain at least one feature map and a second image, wherein the second image is determined based on the at least one feature map, and the at least one feature map is determined based on the first image;
determining, based on the at least one feature map, a target detection box corresponding to the second image; and
determining training data based on the second image and the target detection box corresponding to the second image.

2. The method according to claim 1, further comprising:
obtaining image generation constraint information corresponding to the first image; and
the performing an image generation process on the first image, to obtain at least one feature map and a second image comprises:
performing the image generation process on the first image based on the image generation constraint information, to obtain the at least one feature map and the second image, wherein the at least one feature map is determined based on the first image and the image generation constraint information.

3. The method according to claim 2, wherein the performing the image generation process on the first image based on the image generation constraint information, to obtain the at least one feature map and the second image comprises:
determining the at least one feature map and the second image by using a first diffusion model that is pre-constructed, the image generation constraint information, and the first image.

4. The method according to claim 3, wherein the image generation constraint information comprises a condition prompt text; and
the determining the at least one feature map and the second image comprises:
performing feature extraction on the condition prompt text, to obtain a condition prompt feature; and
inputting the condition prompt feature and the first image into the first diffusion model, to obtain the at least one feature map and the second image.

5. The method according to claim 3, wherein the first diffusion model comprises a denoising module and a decoding module, wherein the denoising module is configured to perform a plurality of noise reduction processes on input data of the denoising module, and input data of the decoding module comprises a processing result of a last noise reduction process;
the at least one feature map is determined based on an intermediate feature generated during the last noise reduction process; and
the second image is determined based on output data of the decoding module.

6. The method according to claim 2, wherein the image generation constraint information comprises at least one of a group consisting of a random seed, an encoding rate, a guidance scale, and a condition prompt text.

7. The method according to claim 2, wherein after the determining training data based on the second image and the target detection box corresponding to the second image, the method further comprises:
adjusting part or all of constraint items in the image generation constraint information, and continuing to perform a step of performing the image generation process on the first image based on the image generation constraint information, to obtain the at least one feature map and the second image, until a first end condition is satisfied.

8. The method according to claim 7, wherein the obtaining a first image comprises:
determining the first image from a training dataset;
the determining training data based on the second image and the target detection box corresponding to the second image comprises:
updating the training dataset by using the second image and the target detection box corresponding to the second image; and
the method further comprises:
when the first end condition is satisfied, continuing to perform a step of determining the first image from the training dataset, until a second end condition is satisfied.

9. The method according to claim 1, wherein the determining, based on the at least one feature map, a target detection box corresponding to the second image comprises:
processing the at least one feature map by using a first detection network that is pre-constructed, to obtain the target detection box corresponding to the second image.

10. The method according to claim 9, wherein a construction process of the first detection network comprises:
training a first data processing model by using a plurality of third images and a detection box label corresponding to each of the plurality of third images, wherein the first data processing model comprises a second diffusion model and a second detection network, and a parameter in the second diffusion model is not updated during a training process of the first data processing model; and
determining the first detection network based on a second detection network in a trained first data processing model.

11. The method according to claim 10, wherein the second image is generated by using a first diffusion model that is pre-constructed; and
the second diffusion model is determined based on the first diffusion model.

12. The method according to claim 10, wherein the second image is generated by using a first diffusion model that is pre-constructed; the first diffusion model is used to perform a first number of noise reduction processes; and
the second diffusion model is used to perform a second number of noise reduction processes, wherein the second number is less than the first number.

13. The method according to claim 10, wherein the training process of the first data processing model comprises:
determining an image to be used from the plurality of third images;
inputting the image to be used into the first data processing model, to obtain a detection box prediction result corresponding to the image to be used and output by the first data processing model; and
updating the second detection network in the first data processing model based on the detection box prediction result and the detection box label, and continuing to perform a step of determining an image to be used from the plurality of third images, until a preset stop condition is satisfied.

14. The method according to claim 13, wherein the detection box prediction result is determined by the second detection network through processing at least one feature map corresponding to the image to be used, and
the at least one feature map corresponding to the image to be used is determined by the second diffusion model through processing the image to be used.

15. The method according to claim 9, wherein the at least one feature map comprises a plurality of feature maps, and sizes of different feature maps are different; and
the processing the at least one feature map by using a first detection network that is pre-constructed, to obtain the target detection box corresponding to the second image comprises:
constructing a pyramid feature by using the plurality of feature maps; and
inputting the pyramid feature into the first detection network, to obtain the target detection box corresponding to the second image.

16. The method according to claim 1, wherein a process of determining the second image and the target detection box corresponding to the second image comprises:
determining, by using a second data processing model that is pre-constructed and the first image, the second image and the target detection box corresponding to the second image, wherein the second data processing model comprises a first diffusion model and a first detection network; the first diffusion model is used to perform the image generation process on the first image, to obtain the at least one feature map and the second image; and the first detection network is used to determine, based on the at least one feature map, the target detection box corresponding to the second image.

17. A target detection method, comprising:
obtaining an image to be detected; and
inputting the image to be detected into a target detection model that is pre-constructed, to obtain a target detection result output by the target detection model, wherein the target detection model is constructed based on training data; and the training data is determined by using a training data determination method, the training data determination method comprises:
obtaining a first image;
performing an image generation process on the first image, to obtain at least one feature map and a second image, wherein the second image is determined based on the at least one feature map, and the at least one feature map is determined based on the first image;
determining, based on the at least one feature map, a target detection box corresponding to the second image; and
determining training data based on the second image and the target detection box corresponding to the second image.

18. (canceled)

19. (canceled)

20. An electronic device, comprising a processor and a memory, wherein
the memory is configured to store instructions or a computer program; and
the processor is configured to execute the instructions or the computer program in the memory, to cause the electronic device to:
obtain a first image;
perform an image generation process on the first image, to obtain at least one feature map and a second image, wherein the second image is determined based on the at least one feature map, and the at least one feature map is determined based on the first image;
determine, based on the at least one feature map, a target detection box corresponding to the second image; and
determine training data based on the second image and the target detection box corresponding to the second image.

21. A non-transitory computer-readable medium having instructions or a computer program stored therein, wherein the instructions or the computer program, when run on a device, causes the device to perform the method according to claim 1.
